(19) United States
(12) Patent Application Publication
(10) Pub. No.: US 2006/0272308 A1
(43) Pub. Date: Dec. 7, 2006

(54) Mounting hitch

(75) Inventor: Nickolas T. Moore, Beatrice, NE (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Electrolux Professional Outdoor Products, Inc., Cleveland, OH (US)

(21) Appl. No.: 11/144,328

(22) Filed: Jun. 3, 2005

(51) Int. Cl. A01D 43/06

(52) U.S. Cl. 56/194

(57) ABSTRACT

The invention provides a mounting hitch for attaching an accessory, such as a grass collection unit, to a vehicle, such as a riding lawn mower. The lower portion of the hitch is disposed relatively close to the ground to aid with the mounting of the hitch to the riding mower. Being mountable relatively close to the ground also allows the riding mower to maintain a relatively low center of gravity such that the riding mower is relatively resistant to tipping when cutting on a hill or other uneven surface. The mounting hitch comprises a removably attachable portion and hitch attachment portions. The hitch attachment portions are directly connected to the riding mower and comprise structures for receiving the removably attachable portion. The removably attachable portion is mountable to the hitch attachment portions such that a single user is able to mount the hitch to the riding lawn mower.

### FIELD OF THE INVENTION

The invention pertains to hitches, and more specifically, hitches used to mount objects to a vehicle, such as a riding lawn mower.

### BACKGROUND OF THE INVENTION

Mounting hitches are generally well known in the art. They permit an accessory, such as a collection system, to be attached to a vehicle, such as a riding lawn mower. The vehicle has one or more receiving portions for the hitch that are usually disposed relatively high above the ground. Thus, in order to connect these hitches, they must be raised to the level of the receiving portion(s) on the vehicle. Since these types of hitches are often heavy and awkward, they require more than a single individual to lift and mount. Therefore, even if an individual has the strength to lift the hitch (or hitch with the accessory attached) alone, the assistance of another person is still required to attach the hitch to the receiving portion(s). Therefore, there is a need for a mounting hitch that permits a single user to easily attach the hitch to a vehicle, such as a riding lawn mower.

### BRIEF SUMMARY OF THE INVENTION

The invention provides a mounting hitch for attaching accessories, such as a grass collector, to a riding lawn mower. The lower portion of the hitch is disposed relatively close to the ground to aid with the mounting of the hitch to the riding mower. Being mountable relatively close to the ground also allows the riding mower to maintain a relatively low center of gravity. The mounting hitch comprises a removably attachable portion and hitch attachment portions. The hitch attachment portions are directly connected to the riding mower and comprise structures for receiving the removably attachable portion. The removably attachable portion is mountable to the hitch attachment portions such that a single user is able to mount the hitch to the riding lawn mower.

To mount the hitch, a user disposes the lower portion of the hitch near the riding mower. Each side of the lower portion of the hitch is connected to the riding mower. Due to the shape of the hitch and the relatively close proximity to the ground that the hitch is mounted, attaching the lower portions requires minimal, if any, lifting of the hitch. A user can then move to the rear of the hitch and lift the hitch to pivot the hitch upward and forward. Since most of the weight of the hitch is supported by the attachment of the lower portion of the hitch to the riding mower, it is relatively simple for a user to pivot the hitch. As the hitch moves forward, a latch on the hitch engages a receiving portion on the riding mower. The latch locks the hitch in place, and thus, the hitch is now mounted to the riding mower. Additional support in the form of adjustable linkages may be attached between the hitch and the riding mower. This attachment method and the structure of the hitch permitting this attachment method makes the mounting process simple for a single user even if a heavy accessory is attached.

The invention further provides a hitch for connecting an accessory to a riding lawn mower. The hitch comprises a lower mounting portion and an upper mounting portion. The lower mounting portion is for removably and pivotably mounting the hitch to the riding lawn mower. The upper mounting portion is disposed above the lower mounting portion for removably connecting an upper portion of the hitch to the riding lawn mower. If the lower mounting portion is mounted to the riding lawn mower, the hitch can be pivoted toward the riding lawn mower, and the upper mounting portion can secure the hitch to the riding lawn mower

The invention further provides a riding lawn mower for cutting grass. The riding lawn mower comprises a lower receiving portion, an upper receiving portion, and a hitch. The lower receiving portion is disposed near the rear of the riding lawn mower. The upper receiving portion is disposed near the rear of the riding lawn mower and above the lower receiving portion. The hitch comprises a lower mounting portion and an upper mounting portion. The lower mounting portion is removably and pivotably coupled to the lower receiving portion and the upper mounting portion is removably connected to the upper receiving portion.

The invention further provides a method of mounting a hitch to a riding lawn mower. The method comprises disposing the hitch near the riding lawn mower, mounting a lower portion of the hitch to the riding lawn mower, pivoting the hitch upward and toward the riding lawn mower; and attaching an upper mounting portion of the hitch to the riding lawn mower

### BRIEF DESCRIPTION OF THE DRAWINGS

FIG. 1 is a perspective view of a riding mower with a mounting hitch and a collection system attached.

FIG. 2 is a perspective view of the mounting hitch and collection system shown in FIG. 1.

FIG. 3 is another perspective view of the mounting hitch and collection system shown in FIG. 1.

FIG. 4 is a perspective view of the mounting hitch shown in FIG. 1 with a bag collection system.

FIG. 5 is an elevational side view of the bag collection system shown in FIG. 4.

FIG. 6 is a perspective view of the mounting hitch shown in FIG. 1.

FIG. 7 is a side view of the mounting hitch shown in FIG. 1.

FIG. 8 is a perspective view of the mounting hitch shown in FIG. 1 attached to a riding mower chassis.

FIG. 9 is an exploded perspective view of the mounting hitch shown in FIG. 1 and a riding mower chassis.

FIG. 10 is a perspective view of a removably attachable portion of the mounting hitch shown in FIG. 1.

FIG. 11 is an elevational side view showing the removably attachable portion of FIG. 10 disposed near hitch attachment portions.

FIG. 12 is an elevational side view showing the removably attachable portion of FIG. 10 attached to a hitch bracket.

FIG. 13 is another elevational side view showing the removably attachable portion of FIG. 10 attached to a hitch bracket.

FIG. 14 is an elevational side view showing the removably attachable portion of FIG. 10 attached to a hitch bracket and rear guard.

FIG. 15 is an elevational side view showing the removably attachable portion of FIG. 10 attached to a hitch bracket, rear guard, and support bracket.

### DETAILED DESCRIPTION OF THE INVENTION

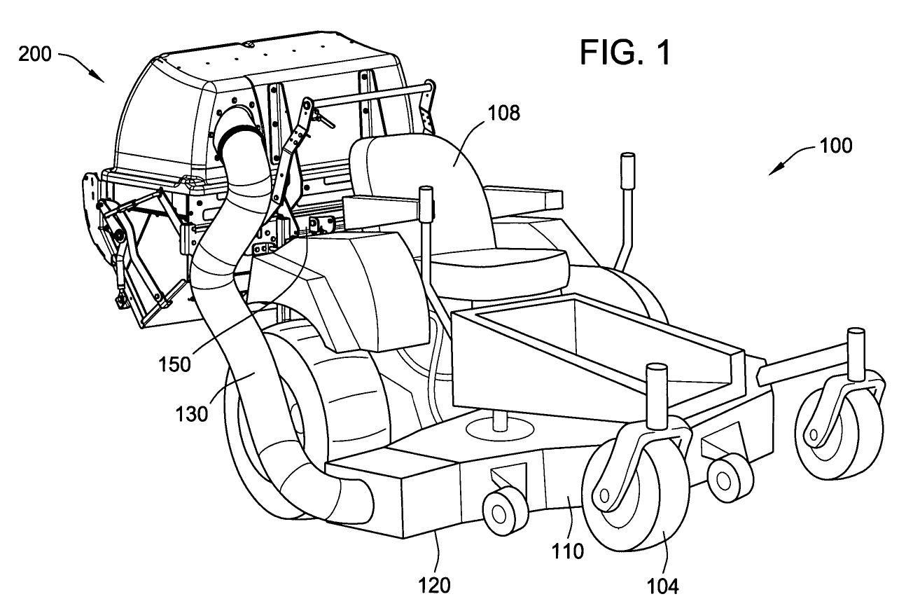

Turning to the figures, there is shown in FIG. 1, a riding mower 100 with a mounting hitch 150 and collection system 200 attached thereto. The riding mower 100 may include a chassis 102, wheels 104, a motor 106, and a seat 108. The riding mower 100 has a cutting deck 110 that includes one or more cutting blades (not shown) that are used to trim blades of grass. Oftentimes, as the blades of grass are trimmed, they are directed through a side exit on the cutter deck 110 and back onto the user's lawn. Frequently, however, it is desirable to collect the grass trimmings in a collection system 200 mounted to the rear of the mower 100. The collection system 200 is mounted via a mounting structure such as the mounting hitch 150 described in further detail below. As shown, a blower assembly 120 may be mounted on the cutting deck 110 such that as grass is discharged out of the cutting deck 110, the grass passes into the blower assembly 120. The blower assembly 120 has an internal impeller. The grass exits out of the rear of the blower assembly 120 into a hose 130. The grass is forced up the hose 130 from the air flow that is created from the impeller and the deck 110. As the grass exits the hose 130, it is dispersed into the collection system 200. The blower may be located at another position along the hose 130. For example, the blower may be located near the collection system 200.

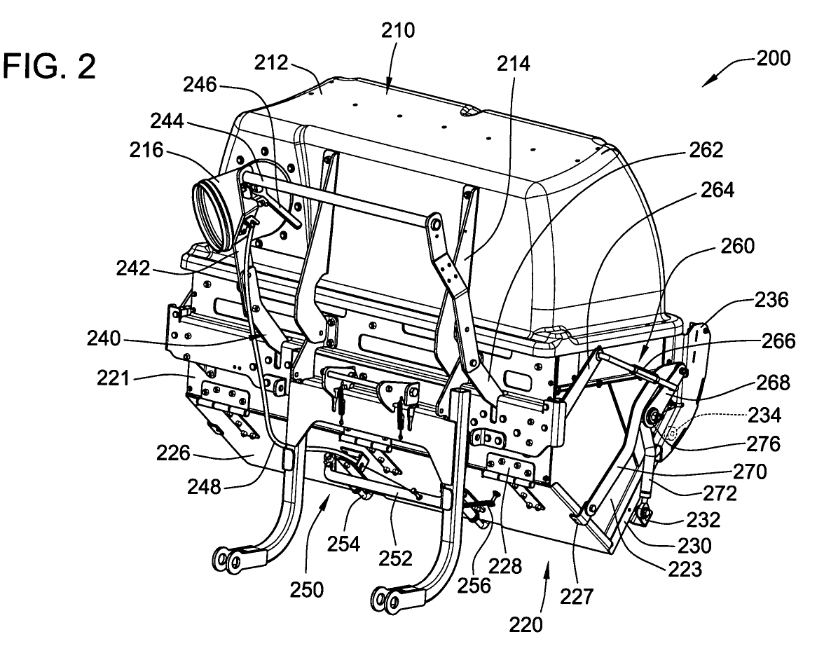

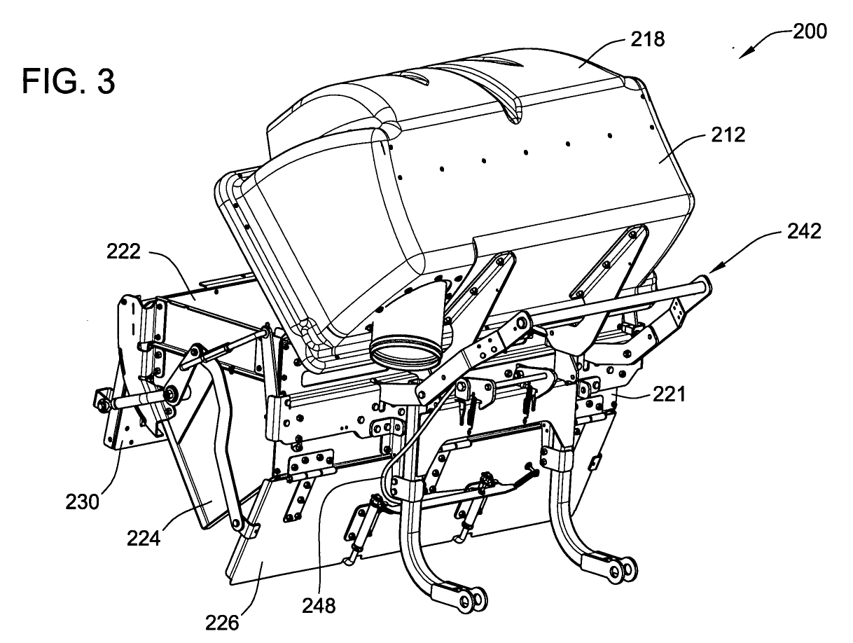

As described above, the mounting hitch 150 may be used to attach an accessory, such as a collection system 200 having a dumping mechanism, to the riding mower 100. An example of such a dumping mechanism is shown in FIGS. 2 and 3, and is described in more detail in U.S. patent application Ser. No. ______ (LVM Matter No. 235458, Express Mail Number EV420402993US, Inventor Nickolas T. Moore), filed Jun. 3, 2005, and entitled “COLLECTION SYSTEM,” which is incorporated by reference in its entirety herein. This type of collection system 200 permits an operator to transport grass clippings via the riding mower 100 to a location where the clippings are to be disposed, and allows the operator to dump the clippings via a dumping mechanism at a desired location without leaving the seat of the mower 100.

The collection system 200 may comprise a hood assembly 210, a hopper assembly 220, and a dumping actuation assembly 240. The hood assembly 210 may comprise a hood 212, a hood hinge 214, a hose receiving portion 216, and a ventilation portion 218. The hopper assembly 220 may comprise a front wall 221, a rear wall 222, sidewalls 223, 224, a support plate 225, a forward door 226, a rear door 230, and tracks 236. The forward door 226 may comprise forward door lift tabs 227 and forward door hinges 228. The rear door 230 may comprise rear door lift tabs 232 and roller bearings 234. The dumping actuation assembly 240 may comprise a handle assembly 242, a latch assembly 250, and a linkage assembly 260. The handle assembly 242 may comprise a handle 244, a grip 246, and a cable 248. The latch assembly 250 may comprise a latch strap 252, a latch pin 254, and a latch tension spring 256. The linkage assembly 260 may comprise handle links 262, link arms 264, adjustable links 266, links 268, forward door lift arms 270, rear door lift arms 272, shaft 274, and bushing 276.

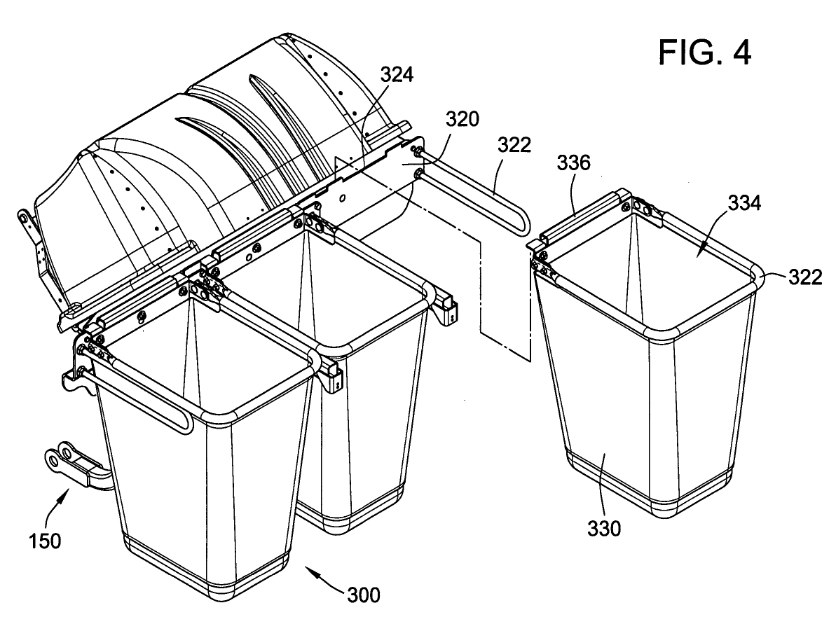

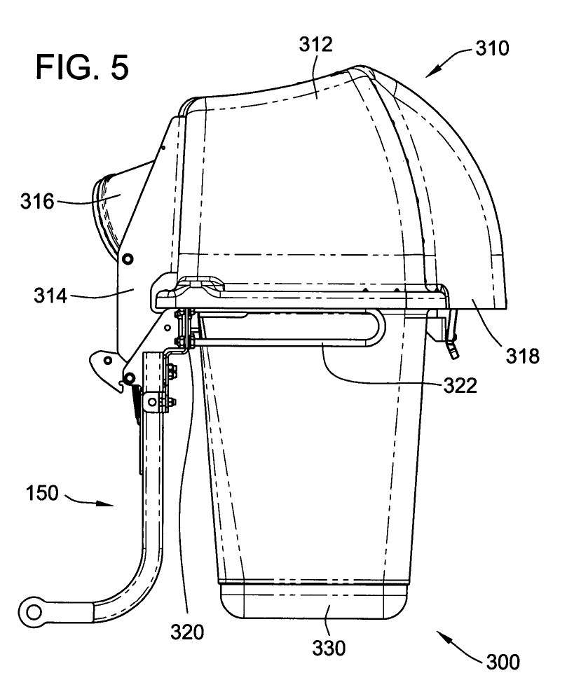

Other types of collection systems, such as the bag collection system 300 shown in FIGS. 4 and 5, may be utilized with a mounting hitch 150. The bag collection system 300 comprises a hood assembly 310, a bag support structure 320, and one or more bags 330 that are removably attachable from the collection system 300. A hose 130 connects the cutting deck 110 to the hood 312 such that the grass clippings travel through the hose 130 from the cutting deck 110 to the collection system 200. Oftentimes, a blower assembly 120 as described above is utilized to aid the transport of the grass clippings through the hose 130.

The hood assembly 310 may comprise a hood 312, a hood hinge 314, a hose receiving portion 316, and a ventilation portion 318. The bag support structure 320 may comprise support arms 322 and a hanger receiving portion 324. The collection bags 330 comprise a frame 332 disposed at the mouth 334 of the bags 330 and a bag hanger 336. The frame 332 rests on the support arms 322 and the bag hanger 336 rests on the hanger receiving portion 324 when the bags 330 are attached to the collection system 300. The collection bags 330 are removably attachable so that a user can remove the bags 330 when they become full. To empty the bags 330, the user removes the bags 330 from the collection system 300 and dumps the contents of the bags 330 at a desired location, typically by inverting the bags 330 such that the grass clippings can escape through the mouth 334 of the bags 330.

Although two examples of collection systems 200, 300 are described above, any suitable grass collection system may be utilized with the mounting hitch 150 of the present invention. Moreover, the mounting hitch 150 is not limited for use with collection systems and may be utilized with any suitable accessory that may be attached to a riding lawn mower 100, such as a fertilizer dispenser, seeder, sprayer, aerator, dethatcher, etc.

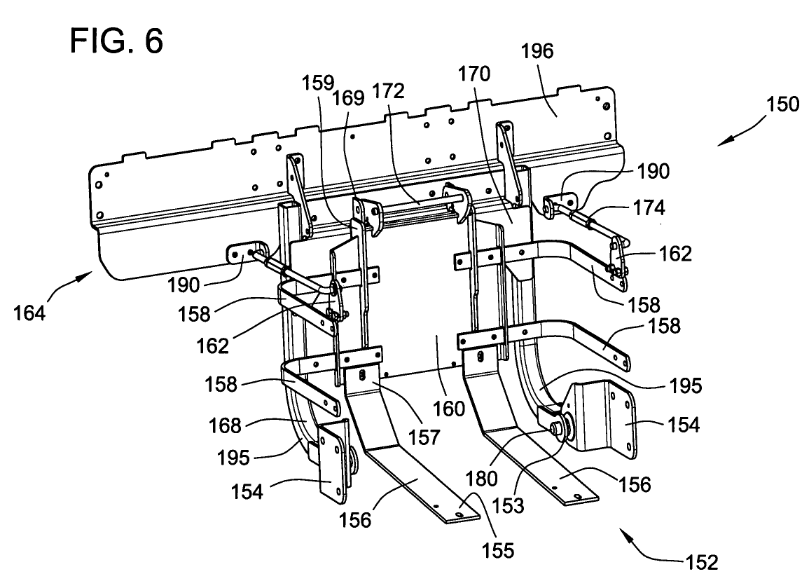

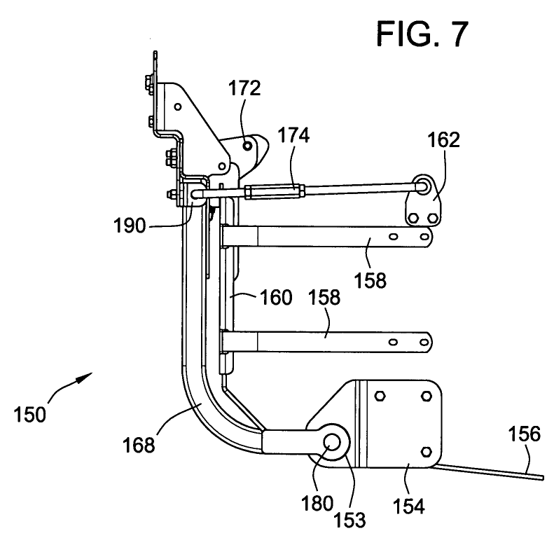

Turning to FIGS. 6-9, there is shown a mounting hitch 150. The hitch 150 permits a user to attach one or more accessories to a vehicle, such as a riding lawn mower 100. The hitch 150 is designed to permit a single user to relatively easily attach the hitch 150 to the riding mower 100. The mounting hitch 150 comprises a removably attachable portion 164 that may be mounted to the riding mower 100 without the need for tools, and one or more hitch attachment portions 152 that receive the removably attachable portion 164 and secure it to the mower 100.

The hitch attachment portions 152 may be individual components that may be connected to the riding mower 100, or they may be constructed as part of the riding mower 100. They may be provided pre-attached or formed as part of the riding mower 100 so that a user is able to connect the removably attachable portion 164 without any prior installation. Alternately, when the hitch attachment portions 152 are individual components, they permit a user to attach and remove components as desired, and they also allow a user to purchase them individually and attach them to a previously purchased riding mower 100.

The hitch attachment portions 152 are typically attached to a relatively sturdy portion of the riding mower, such as the lawn mower chassis 102. The hitch attachment portions 152 comprise one or more hitch brackets 154, one or more skid plates 156, one or more support straps 158, a rear guard 160, and one or more support brackets 162. As shown, the hitch brackets 154 may be generally S-shaped and comprise apertures for bolting the hitch brackets 154 to the chassis 102 and a ball joint 153 for receiving a hitch pin 180. Each skid plate 156 comprises a proximal end 155 and a distal end 157. The proximal end 155 attaches to the chassis 102, and the distal end 157 attaches to the rear guard 160. The support straps 158 are generally L-shaped, and similar to the skid plates, one leg of the L is connected to the chassis 102 and the other leg is connected to the rear guard 160. The rear guard 160 is connected indirectly to the chassis 102 via the skid plate 156 and support strap 158 as described above. The rear guard 160 comprises a hitch centering lobe 159 and a latch flange 161, which will be described in further detail below. The support brackets 162 comprise apertures for connecting the support brackets 162 to the chassis 102 and an aperture for attaching an adjustable support linkage 174, described in more detail below. Any suitable hitch attachment portions 152 may be utilized such that the removably attachable portion 164 can be securably mounted to the riding mower 100.

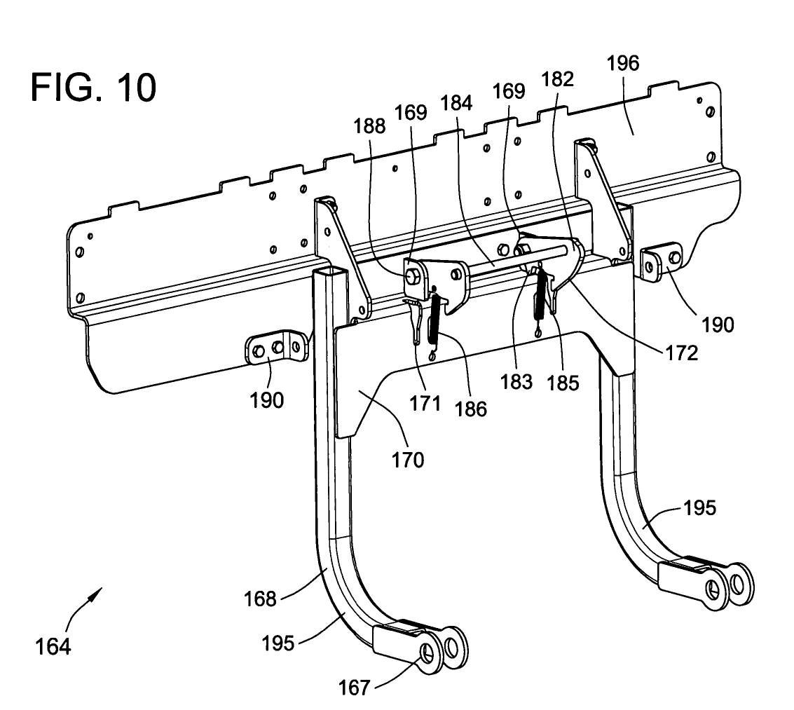

The removably attachable portion 164 has a structure that permits it to be relatively easily mounted and removed from a riding mower 100 by a single user. As shown in FIG. 10, the removably attachable portion 164 of the mounting hitch 150 may comprise a hitch weldment 168, a latch 172, and one or more adjustable linkages 174. The hitch weldment 168 may comprise an aperture 167 for receiving a hitch pin 180. The hitch weldment 168 may also comprise one or more generally L-shaped members 195 with a first portion having the aperture 167 and a second portion attached to the support plate 170. The support plate 170 has one or more protruding members 169 for pivotally attaching a latch 172. The support plate 170 may also comprise one or more centering slots 171 to assist with the proper alignment of the rear guard 160 with the support plate 170. Further, the hitch weldment 168 may be attached to a main support member 196 for an accessory. The main support member 196, if provided, may be any suitable shape or size.

The latch comprises latch weldments 182, a latch handle 184, and one or more tension springs 186. The latch weldments 182 comprise apertures for attaching the latch weldments 182 to the support plate 170, connecting the handle 184, and receiving a tension spring 186. The latch weldments 182 also comprise a stop tab 183 for preventing the advancement of the rear guard 160 beyond the stop tab 183, and a latch notch 185 for receiving the latch flange 161 of the rear guard 160. The latch weldments 182 are pivotably attached to the protruding members 169 on the support plate 170 at a latch pivot point 188. The latch handle 184 is disposed between and is connected to both latch weldments 182. The tension springs 186 are disposed between the latch weldments 182 and the support plate 170 to aid in the retention of the hitch weldment 168 to the rear guard 160 when the hitch 150 is attached to the riding mower 100.

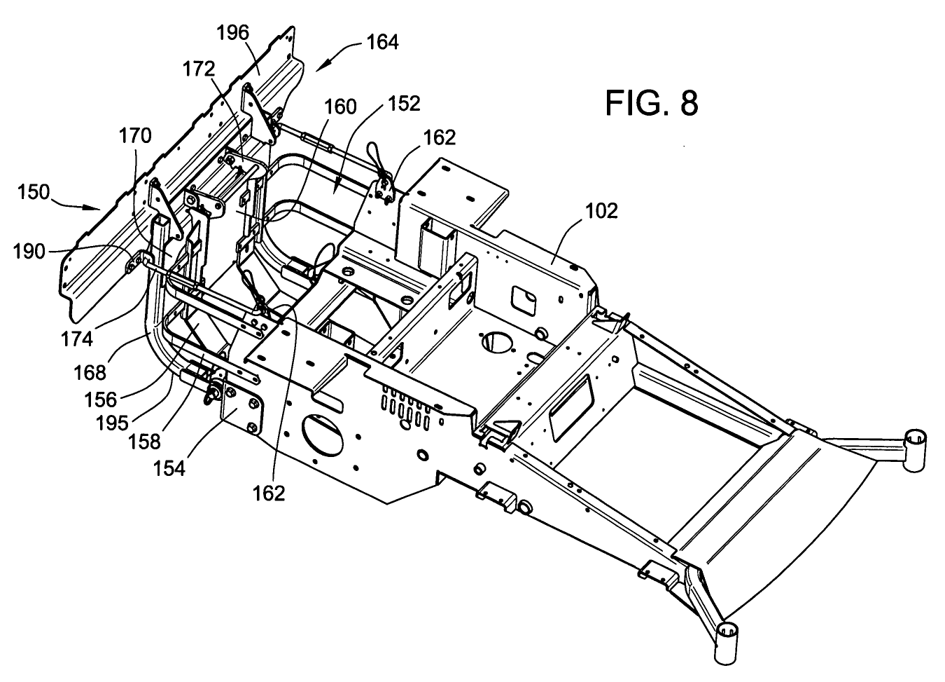

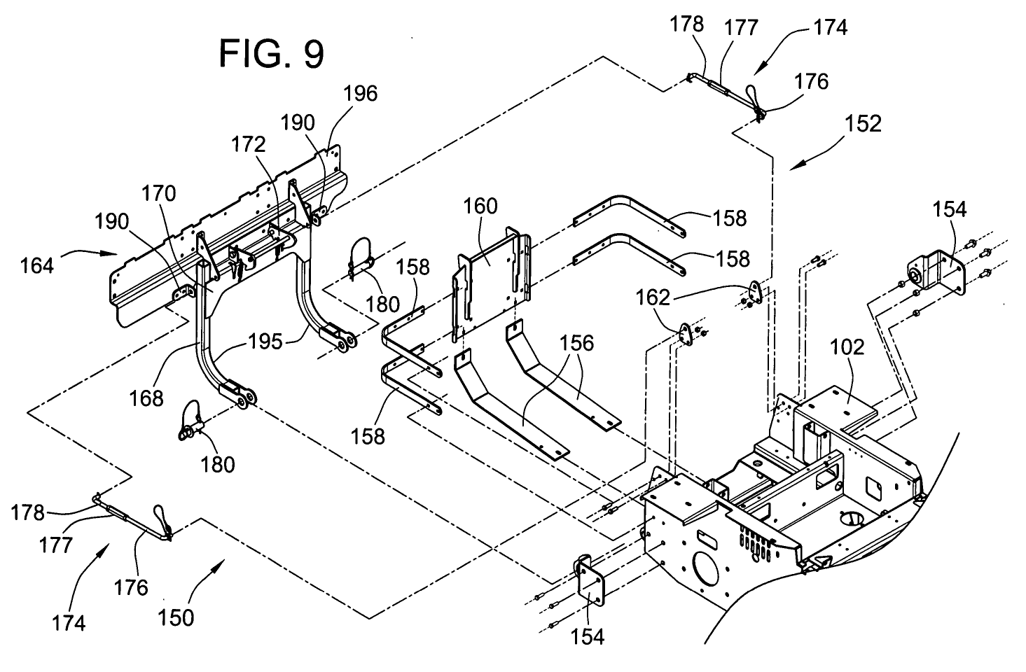

Turning back to FIGS. 8 and 9, an adjustable support linkage 174 may be provided to add additional support to the mounting hitch 150 when it is mounted to the riding mower 100. The adjustable support linkage 174 comprises a proximal L-shaped member 176, a middle adjustment mechanism 177, and a distal L-shaped member 178. An end of the distal member 178 may be connected to a support bracket 190 attached, for example, to the support plate 170 or the main support member 196. An end of the proximal member 176 may be connected to the riding mower 100 directly or otherwise attached to a support bracket 162 connected to the riding mower 100. The adjustment mechanism 177 allows a user to extend or contract the adjustable support linkage 174 as necessary to line up the proximal and distal members 176, 178 with their respective support brackets 162, 190. Adjustment is made by rotating the middle adjustment mechanism 177.

The removably attachable portion 164 is connectable to the hitch bracket 154, the rear guard 160, and the support bracket 162 to allow a user to mount a grass collection system 200, 300 or other accessory to a riding mower. Thus, the mounting hitch 150 may have three separate types of support structures to provide a secure attachment of the hitch 150 to the riding mower 100. This enhances the stability of the mounting hitch 150 and the accessory attached to the mounting hitch 150.

The following example further illustrates the invention but, of course, should not be construed as in any way limiting its scope. As mentioned above, the mounting hitch 150 may be used to mount a grass collection system 200, 300 to the rear of a riding mower 100. The individual hitch attachment portions 152 may be constructed as part of the riding mower 100, may be attached to the riding mower 100 prior to the user receiving the riding mower 100, and/or may be provided as individual components that the user may attach to the riding mower 100.

When the hitch attachment portions 152 are provided as individual components to the user, the user attaches these portions before attaching the removably attachable portion 164. Two hitch brackets 154 and two support brackets 162 are bolted or otherwise connected directly to the mower 100. The rear guard 160 is bolted or otherwise attached to four support straps 158 and two skid plates 156. The support straps 158 and skid plates 156 are also bolted or otherwise attached to the chassis 102 of the mower 100.

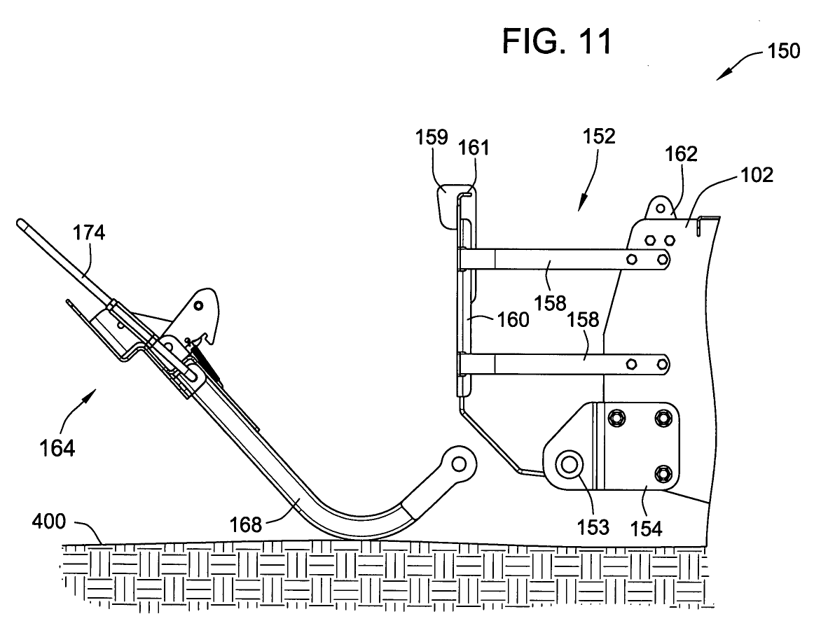

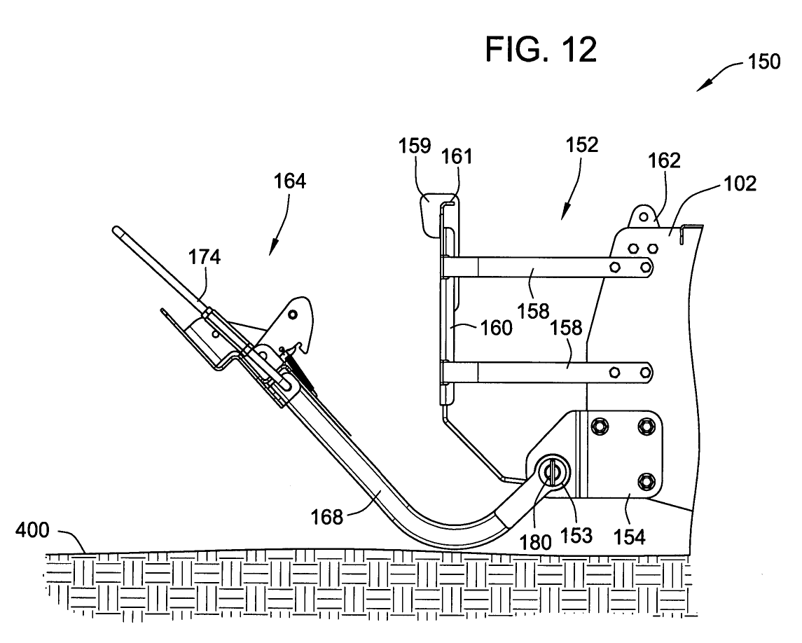

To mount the hitch weldment 168 to the mower 100, the hitch weldment 168 is placed on the ground 400 near the rear of the mower 100 as shown in FIG. 11. Turning to FIG. 12, the aperture 167 of the hitch weldment 168 is lined up with the hitch bracket 154 on one side of the mower 100, and a hitch pin 180 is placed through the aperture 167 and the hitch bracket 154. The hitch 150 is designed such that it need only to be lifted slightly, if at all, to align these apertures. A key ring or other suitable device may be disposed through an aperture in the hitch pin 180 to prevent the hitch pin 180 from laterally sliding out of the aperture 167 and hitch bracket 154. This process is repeated on the other side of the hitch 150. At this point, the lower portion of the hitch 150 is attached to the riding mower 100.

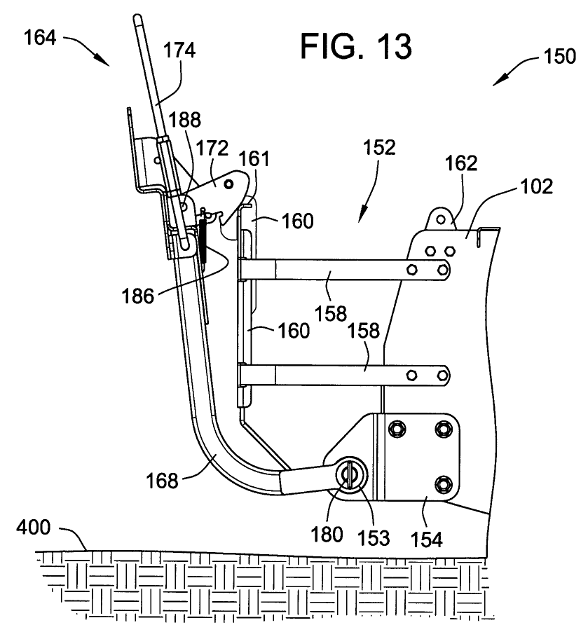

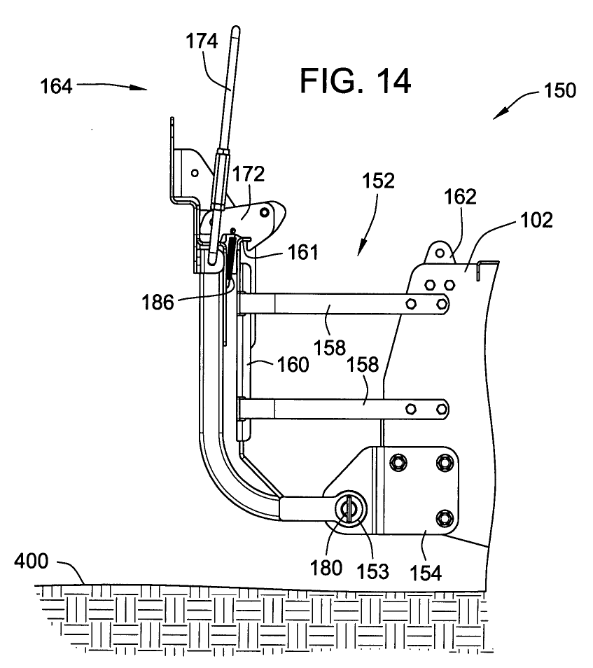

Once the lower portion of the hitch 150 is secured to the riding mower 100, a user may move to the rear of the hitch 150 and lift the removably attachable portion 164 to pivot the removably attachable portion 164 around the hitch pins 180. Referring to FIG. 13, as the removably attachable portion 164 is rotated toward the rear of the riding mower 100, the latch 172 will contact the upper portion of the rear guard 160. As the hitch 150 continues to pivot further, the latch 172 pivots around a latch pivot point 188. A follower edge of the latch 172 will follow the formed radius of the latch flange 161 on the rear guard 160 and extend the tension springs 186. Once the follower edge of the latch 172 terminates, the tension springs 186 will pull down on the latch 172 to cause the latch flange 161 of the rear guard 160 to engage the latch notch 185 of the latch weldment 182. The hitch centering lobe 159 is received by the centering slots 171 on the support plate 170. The hitch centering lobe 159 prevents the latch 172 from engaging unless the removably attachable portion 164 is centered. As shown in FIG. 14, this secures the upper portion of the hitch 150 to the mower 100.

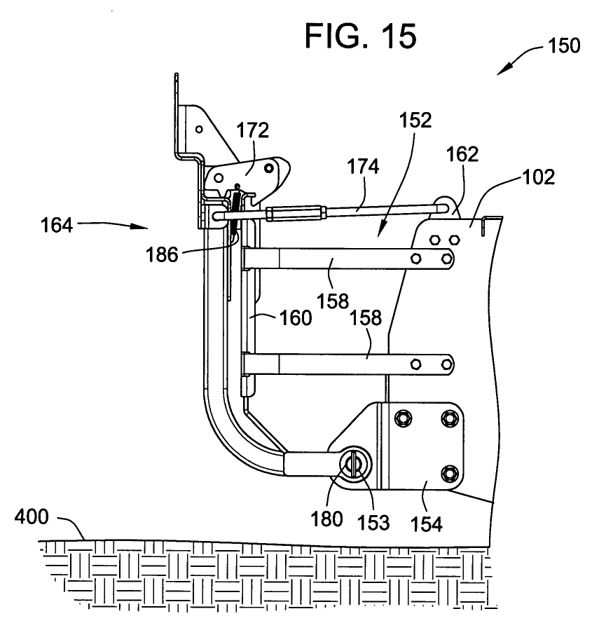

Turning to FIG. 15, the ends of the adjustable support linkages 174 are inserted into a respective aperture in the support brackets 162, 190, and a key ring or other suitable device may be used to prevent the adjustable support linkages 174 from disengaging the support brackets 162, 190. Alternately, the adjustable support linkages 174 may be already attached to one of the support brackets 162, 190 prior to attachment. Adjustment of the middle adjustment mechanism 177 on the adjustable support linkages 174 may be required to obtain proper alignment of the linkage 174 and the aperture in the support brackets 162, 190. Once this has been completed, the hitch 150 is secured to the mower 100.

To remove the hitch 150, the key rings or other devices are removed from the adjustable support linkages 174, and the adjustable support linkages 174 are detached from the apertures on one or both of the support brackets 162, 190. The user may move the removably attachable portion 164 forward toward the riding mower 100, and the latch handle 184 may be lifted to free the latch 172 from the rear guard 160 and permit the mounting hitch 150 to rotate back and downward around the hitch pins 180. Once the hitch weldment 168 is supported on the ground, the key rings or other securing devices are removed from the hitch pins 180, and the hitch pins 180 are removed from the aperture 167 and hitch brackets 154. The removably attachable portion 164 of the hitch 150 is now completely disconnected from the riding mower 100.

Any one or more of the individual components described above may be formed as part of one or more single components.

The mounting hitch may be utilized with any suitable vehicle.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hitch for connecting an accessory to a riding lawn mower, the hitch comprising:
a lower mounting portion for removably and pivotably mounting the hitch to the riding lawn mower; and
an upper mounting portion disposed above the lower mounting portion for removably connecting an upper portion of the hitch to the riding lawn mower;
such that if the lower mounting portion is mounted to the riding lawn mower, the hitch can be pivoted toward the riding lawn mower, and the upper mounting portion can secure the hitch to the riding lawn mower.

2. The hitch of claim 1 wherein the upper mounting portion is a latch mechanism.

3. The hitch of claim 1 wherein the upper mounting portion is a support member.

4. The hitch of claim 1 further comprising a second upper mounting portion.

5. The hitch of claim 1 further comprising a frame connecting the upper mounting portion with the lower mounting portion.

6. The hitch of claim 5 wherein the frame comprises a substantially L-shaped member.

7. The hitch of claim 1 further comprising an accessory attachment portion.

8. The hitch of claim 1 further comprising an accessory.

9. The hitch of claim 8 wherein the accessory is a grass collection system.

10. The hitch of claim 1 further comprising a centering portion.

11. A riding lawn mower for cutting grass, the riding lawn mower comprising:
a lower receiving portion disposed near the rear of the riding lawn mower;
an upper receiving portion disposed near the rear of the riding lawn mower and above the lower receiving portion; and
a hitch comprising a lower mounting portion and an upper mounting portion, the lower mounting portion being removably and pivotably coupled to the lower receiving portion and the upper mounting portion being removably connected to the upper receiving portion.

12. The riding lawn mower of claim 11 wherein the lower receiving portion comprises an aperture for receiving the lower mounting portion.

13. The riding lawn mower of claim 11 wherein the upper receiving portion comprises an aperture for receiving the upper mounting portion.

14. The riding lawn mower of claim 11 wherein the upper receiving portion comprises a flange for receiving the upper mounting portion.

15. The riding lawn mower of claim 11 further comprising a second upper receiving portion and wherein the hitch comprises a second upper mounting portion removably connected to the second upper receiving portion.

16. The riding lawn mower of claim 11 wherein at least one of the lower receiving portion and the upper receiving portion are removably attached to the riding lawn mower.

17. A method of mounting a hitch to a riding lawn mower comprising:
disposing the hitch near the riding lawn mower;
mounting a lower portion of the hitch to the riding lawn mower;
pivoting the hitch upward and toward the riding lawn mower; and
attaching an upper mounting portion of the hitch to the riding lawn mower.

18. The method of claim 17 further comprising attaching a second upper mounting portion of the hitch to the riding lawn mower.

19. The method of claim 17 further comprising connecting an accessory to the hitch.

20. The method of claim 19 wherein the accessory is a grass collection system.

21. The method of claim 17 further comprising attaching a lower receiving portion and an upper receiving portion to the riding lawn mower.

22. A hitch for connecting an accessory to a vehicle, the hitch comprising:
a lower mounting portion for removably and pivotably mounting the hitch to the vehicle; and
an upper mounting portion disposed above the lower mounting portion for removably connecting an upper portion of the hitch to the vehicle;
such that if the lower mounting portion is mounted to the vehicle, the hitch can be pivoted toward the vehicle, and the upper mounting portion can secure the hitch to the vehicle.
